(19) United States
(12) Patent Application Publication
(10) Pub. No.: US 2015/0213481 A1
(43) Pub. Date: Jul. 30, 2015

(54) OPTIMIZATION OF ADVERTISEMENTS

(71) Applicant: Jian Yuan, Mountain View, CA (US)

(72) Inventor: Jian Yuan, Mountain View, CA (US)

(73) Assignee: GOOGLE INC., Mountain View, CA (US)

(21) Appl. No.: 12/332,724

(22) Filed: Dec. 11, 2008

(51) Int. Cl. G06Q 30/02; G06F 17/30; G06F 7/06

(52) U.S. Cl. CPC G06Q 30/0244

(57) ABSTRACT

An ad optimizer includes a suggestion tool to provide suggestions on descriptors based on, for example, ad creatives. The suggestion tool receives, through a user interface, an input identifying an advertisement that is associated with an ad creative and at least one ad descriptor. The suggestion tool analyzes the ad creative and generates one or more suggested descriptors based on the analysis of the ad creative, and outputs the suggested descriptors through the user interface.

### TECHNICAL FIELD

This document generally relates to information management.

### BACKGROUND

Advertisers design advertisements to achieve certain goals, such as to promote products and services or enhance brand recognition. For example, an ad campaign may be executed in which one or more ads are shown in a media (e.g., television, radio, or Internet) over a preset period of time. At the end of the ad campaign, surveys may be given to a sampled group of people to determine the effectiveness of the ad. Based on the results of the surveys, the advertiser may adjust the ad campaign to improve its effectiveness.

### SUMMARY

The present disclosure includes a system, method, and computer program products for providing feedback to advertisers to enable the advertisers to improve performances of advertisements.

In general, in one aspect, a user interface receives input identifying an advertisement that is associated with an ad creative and at least one associated ad descriptor; and a suggestion tool analyzes the ad creative and generates at least one suggested descriptor based on the analysis of the ad creative, and outputs the suggested descriptor through the user interface.

Implementations may include one or more of the following features. A descriptor repository stores a plurality of descriptors, and the suggestion tool can search the descriptor repository to identify the at least one suggested descriptor. The suggestion tool can identify the at least one suggested descriptor based on a matching between the at least one suggested descriptor and content (e.g., text) in the ad creative. The descriptor repository can store historical performances of the descriptors, and the suggestion tool can determine whether the suggested descriptor is likely to perform better than the original provided ad descriptor based on the historical performances of the suggested descriptor and the original provided descriptor, and output the suggested descriptor if the suggested descriptor is likely to perform better than the original provided descriptor. The suggestion tool can identify a topic in the ad creative and search a repository of descriptors to find descriptors that are relevant to the topic. The suggestion tool can be configured to generate a suggested descriptor that has a narrower meaning than an original provided ad descriptor. The original provided ad descriptor can be associated with a genus that includes a plurality of species, and the suggested descriptor can be associated with one of the species. For example, the ad creative can include a product name or a brand name, the original provided ad descriptor can include a broad generic term associated with the product name or brand name, and the suggested descriptor can be the product name or brand name.

In general, in another aspect, a user interface allows a user to identify an advertisement that is associated with a landing web page in which when the advertisement is acted upon by a user, the user is directed to the landing web page; a database stores statistical information associated with the landing web page; and a landing page scoring tool processes the statistical information associated with the landing web page, generates a quality score for the landing web page based on at least two signals obtained from the statistical information, and provides the quality score to the user through the user interface, the quality score providing information about how the landing web page affects a performance of the advertisement.

Implementations may include one or more of the following features. A landing web page having a higher quality score may contribute more positively to the performance of the advertisement than a landing web page having a lower quality score. A landing page improvement tool can provide suggestions for adjusting the landing web page to improve the performance of the advertisement. The landing page scoring tool can generate the quality score based on at least one of page link analysis information, how frequently the landing web page is modified, and performance of ads linked to the landing web page.

In general, in another aspect, a user interface allows a user to identify an advertisement; a database stores statistical information associated with performances of the advertisement in various categories, the various categories including at least one of various geographical regions, various web sites, various categories of web sites, and various time periods; and an ad optimizer collects the statistical information, processes the collected statistical information, and outputs a visual representation of the processed information in the user interface showing relative performances of the advertisement in the various categories.

Implementations may include one or more of the following features. The ad optimizer can provide suggestions for increasing or decreasing ad budgets for particular categories. The statistical information collected by the ad optimizer can include at least one of click through rates and conversion rates of the advertisement. The ad optimizer can include a time tuning tool to identify peer advertisements that target the same viewers as the first advertisement, process statistical information associated with the peer advertisements, and output a visual representation of the processed information in the user interface showing performances of the first advertisement relative to the peer advertisements during various time periods. The various times periods can include different time periods of a day, different days of a week, different months of a year, different seasons of a year, or different holidays of a year.

In general, in another aspect, an input identifying an advertisement that is associated with an ad creative and at least one associated ad descriptor is received; the ad creative is processed and at least one suggested descriptor is generated based on the ad creative; and the suggested descriptor is provided.

In general, in another aspect, an input identifying an advertisement that is associated with a landing web page is received in which when the advertisement is acted upon by a user, the user is directed to the landing web page; statistical information is retrieved from a database storing statistical information associated with the landing web page; the retrieved statistical information is processed to generate a quality score for the landing web page based on at least two signals obtained from the statistical information, the quality score providing information about how the landing web page affects a performance of the advertisement; and the landing web page quality score is provided to the user through the user interface.

In general, in another aspect, an input that identifies an advertisement is received; information is retrieved from a database having statistical information associated with performances of the advertisement in various categories, the various categories including at least one of various geographical regions, various web sites, various categories of web sites, and various time periods; the retrieved statistical information is processed; and a visual representation of the processed information is provided in a user interface showing relative performances of the advertisement in the various categories.

In general, in another aspect, a system includes a user interface to allow a user to identify an advertisement; a database to store at least one of (a) statistical information associated with performances of the advertisement in various geographical regions, (b) statistical information associated with performances of the advertisement at various web sites, (c) statistical information associated with performances of the advertisement at various categories of web sites, and (d) statistical information associated with performances of the advertisement during various time periods; and means for retrieving the statistical information from the database, processing the retrieved statistical information, and outputting a visual representation of the processed information in a user interface showing (i) relative performances of the advertisement in various geographical regions, (ii) relative performances of the advertisement at the various websites, (iii) relative performances of the advertisement at the various categories of websites, and (iv) relative performances of the advertisement during various time periods, respectively.

These and other aspects and features, and combinations of them, may be expressed as methods, apparatus, systems, means for performing functions, program products, and in other ways.

Advantages of the aspects, systems, and methods may include one or more of the following. Advertisers can obtain feedback useful for improving their advertisements. For example, advertisers can obtain suggestions on ad descriptors (e.g., keywords and phrases) that are more effective for the ads, obtain information on the quality of landing pages associated with the ads, obtain information on which geographical location, web sites, types of web sites, or time periods that the ads may perform better. Better ad keywords and phrases can be associated with ads so that user experiences can be improved. The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of an example information system.

FIGS. 2 and 3 are diagrams of example graphical user interfaces.

FIGS. 4-6 are flow diagrams of example processes.

FIG. 7 is a schematic representation of a general computing system.

Like reference symbols in the various drawings indicate like elements.

### DETAILED DESCRIPTION

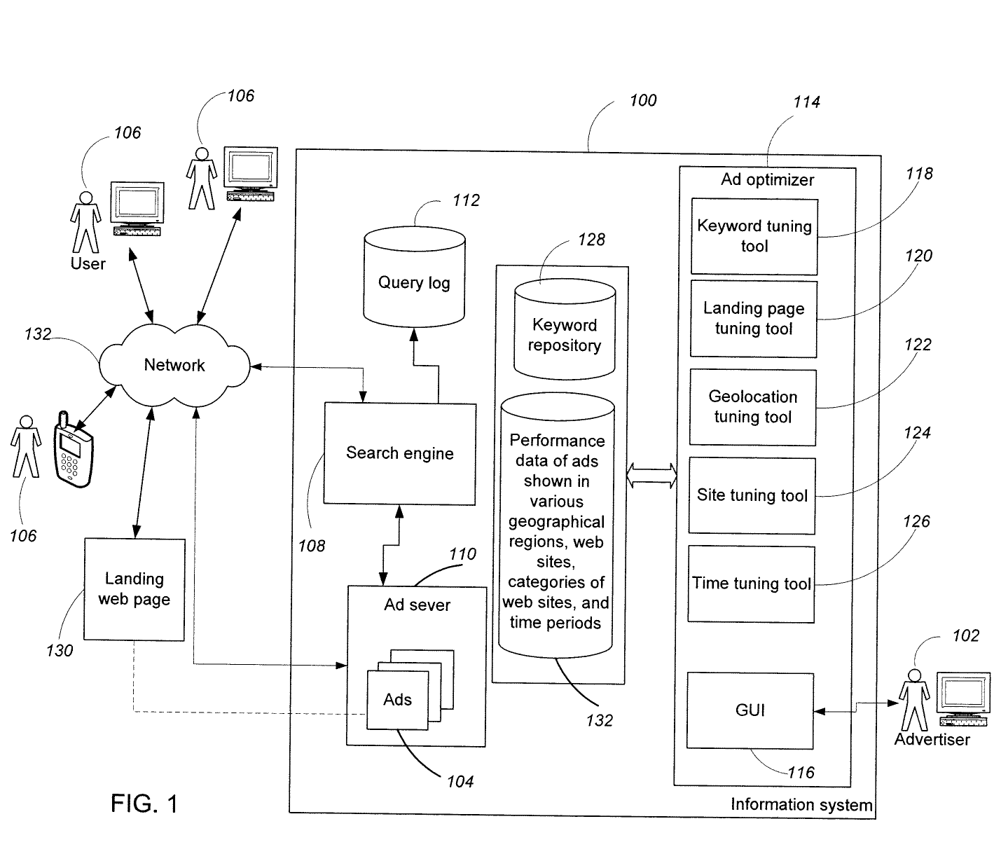

FIG. 1 is a schematic diagram of an example information system 100 that allows advertisers 102 to participate in an ad network and set up ad campaigns to serve advertisements (or ads) 104 to users 106. The advertisements 104 can be designed to achieve certain goals, e.g., to promote products or services, or to enhance brand recognition. The ads 104 can be presented with a variety of on-line content, such as text messages, web pages, and video programs to the users 106. An advertiser 102 can provide descriptors (e.g., keywords or key phrases) that are associated with an ad 104 so that the ad 104 is delivered when, e.g., the keywords or key phrases match certain search terms sent by the users 106, or content that is delivered to the users 106. The system 100 provides feedback to the advertisers 102 to enable the advertisers 102 to improve the ad campaign. The feedback can be provided during the ad campaign or after the end of the ad campaign. While reference is made to advertisements, the information system 100 can deliver other forms of content including other forms of sponsored content.

For example, an ad 104 may include an ad creative and may be associated with one or more ad keywords. The ad creative can define the content of the advertisement that is shown to the users 106. For example, the ad creative can include text, images, audio, videos, and/or other data types, or combinations thereof. The ad creative can also define a layout for the ad 104.

The keywords associated with an ad 104 affect when the ad 104 is presented or served to a user 106. The number of times that an ad 104 is served to a user 106 is referred to as the number of impressions. An advertiser 102 may select keywords using, e.g., words or phrases that a user 106 may enter into a search engine, or words or phrases that frequently appear in online content. When appropriate keywords or key phrases are chosen, there is a higher likelihood that the ad 104 will be presented to users 106 most likely to be interested in the goods or services advertised.

The information system 100 includes a search engine 108 that receives search queries from users 106, searches a database to find results in response to the queries, and delivers the search results to the users 106. An ad server 110 delivers ads 104 based on, for example, the keywords in the search queries or content of the search results. In some examples, the ads 104 are presented with the search results to the users 106. In some examples, links to the ads 104 are provided with the search results to the users 106, and user applications (such as web browsers) retrieve the ads 104 based on the links and display the ads 104 along with the search results.

The search engine 108 stores search queries in a query log 112. The query log 112 includes information useful for determining, for example, which keywords are more frequently searched by users, which keywords have higher performances, etc.

It is important to protect user privacy. For example, access to the search query log 112 can be restricted to ensure user privacy such that only keywords that do not contain personal information can be provided to the advertiser 102. For example, if a keyword appears in search queries from more than a preset number of unique users within a preset number of days, it is unlikely that the keyword includes personal information since the keyword is known to many people.

The system 100 includes an ad optimizer 114 that provides various signals to the advertiser 102 to assist the advertiser 102 to improve the quality of the ad campaign, including adjusting the ad 104 and the ad keywords, for example, to better target the intended audience or to better tailor ad spending. The ad optimizer 114 includes a graphical user interface (GUI) 116 that allows the advertiser 10 to set up the ad campaign and receive feedback from the system 100 about the performance of the ad campaign.

In some implementations, the ad optimizer 114 includes a suggestion tool, e.g., a keyword suggestion tool 118, that analyzes the ad creative and suggests one or more new descriptors (e.g., keywords or key phrases) that are relevant to the ad creative. The keyword suggestion tool 118 may perform a semantic analysis of the text of the ad creative to identify keywords in the ad creative, and identify new keywords based on the keywords in the ad creative.

The system 100 may include a keyword repository 128 storing a plurality of keywords, and the keyword suggestion tool 118 searches the keyword repository 128 to identify keywords that match the keywords in the ad creative. For example, if the ad creative includes text “best BMW dealer in bay area!” and the ad keyword is “cars”, then the keyword suggestion tool 118 may suggest new ad keywords such as “BMW bay area”. Because the original keyword “cars” is quite generic, using the new ad keywords “BMW bay area” may allow the advertiser 102 to more narrowly target users 106 living in the bay area who are interested in BMW vehicles. Users 106 who enter “BMW bay area” in search queries may more likely be interested in BMW vehicles than users 106 who enter “cars” in search queries. By using ad keywords that are more specific or have more narrow meanings than the original ad keywords, the performance of the advertisement 104 may be increased, e.g., resulting in a higher click through rate or conversion rate.

In the example above, the ad server 110 can target search queries that have the keyword “BMW” and a zip code in the bay area. For example, the ad server 110 may deliver the ad 104 when a search query includes the keywords “BMW 94040”, since 94040 is a zip code in Mountain View, which is part of the bay area. This way, the advertiser 102 does not have to create several ad campaigns each targeting an individual zip code in the bay area. The same technique can be used to target other geographical locations.

In some implementations, the keyword repository 128 stores data on historical performances of the keywords, and the keyword suggestion tool 118 identifies new keywords that are likely to perform better than the original ad keyword based on the historical data. For example, suppose the ad creative contains the keyword “rose”, and the original ad keyword provided by the advertiser 102 is “flower”, the keyword suggestion tool 118 may compare the historical performance of the keyword “rose” with that of the keyword “flower”, and determine that “rose” will likely perform better. This may be because “flower” is quite generic and “rose” is more specific. Users 106 who want to buy roses will likely enter “rose” in search queries rather than “flower”.

For example, suppose the ad creative contains the keyword “orchid”, and the original ad keyword is “Phalaenopsis”, the keyword suggestion tool 118 may compare the historical performance of the keyword “orchid” with that of the keyword “Phalaenopsis”, and determine that “orchid” will likely perform better. This may be because “Phalaenopsis” is quite narrow and may result in too few hits.

As the above examples show, the keyword suggestion tool 118 may analyze the ad creative and suggest new keywords that are narrower, broader or of similar scope as the original ad keyword.

In some implementations, the advertiser 102 provides one or more web sites that he wishes to target, and the keyword suggestion tool 118 finds new keywords that are related to both the ad creative and the content of the web sites input by the advertiser 102. The new keywords can be identified based on, for example, a broad match, an exact match, or a phrase-match of the keywords in the ad creative and the words in the web sites input by the advertiser 102.

In some examples, when an advertisement 104 is acted upon by a user 106, the user 106 is directed to a landing web page 130. The advertisement 104 may be designed to be clicked on or has a pattern representing a link to the landing web page 130. For example, the advertisement 104 may be shown on a web page and may be associated with a link such that when the user 106 clicks on the ad 104, the web browser shows the landing web page 130 to the user 106. The ad 104 may include a pattern, and the ad 104 may be shown in various media such as a computer display, a printed publication, or a billboard. In some examples, a user 106 takes an image of the pattern using a camera of a mobile phone, and appropriate software analyzes the pattern to determine the address of the landing web page 130, and the browser executing on the mobile phone shows the landing web page 130 on a display of the mobile phone.

In some implementations, the ad optimizer 114 may include a landing page tuning tool 120 that provides the advertiser 102 a score indicating a quality of the landing web page 130, which provides information about how the landing web page 130 affects the performance of the ad 104. For example, if the landing web page 130 is poorly designed, even when the user 106 is attracted to the landing web page 130 through the ad 104, the user 106 may not spend much time at the landing web page 130 and may not purchase any product or service associated with the landing web page 130. On the other hand, a landing web page 130 having a high quality score may contribute positively to the performance of the advertisement 104. For example, the landing web page 130 may provide highly informative content relevant to the users' interest, leading to a high conversion rate.

In some examples, an advertiser 102 may feel that his ad 104 is not performing as well as expected because the bid price is not high enough compared to competitors, and may decide to increase the bid price to buy a more favorable placement for the ad 104. It is possible that the low performance of the ad 104 has less to do with the placement of the ad 104, and has more to do with the low quality of the landing web page 130. For example, perhaps the landing web page 130 has a poor layout design or has uninteresting content. Providing landing web page quality scores to advertisers 102 may assist the advertisers 102 in deciding whether improving the landing web pages 130 may have a greater impact on the ad performance, rather than focusing on bidding higher on the ads 104. The potential savings can be huge for advertisers 102 having large ad campaigns.

The landing page quality score can be calculated using several methods. For example, the quality score can be based on a page link analysis score, freshness of the page, and the average performance of ads linked to the page. The page link analysis score may be generated based on any of a number of criteria including inferred opinion and structure of the documents. For example, a network's link structure can be used as an indicator of an individual page's value. A link from page A to page B can be interpreted as a vote, by page A, for page B. Votes cast by pages that are themselves important weigh more heavily and help to make other pages important. The page can also be scored based on locations and frequencies of keywords within the page. For example, if the keywords are located in the HTML title tag of the page, or if the keywords appear more frequently in the page, the page link analysis score may become higher.

The freshness of the landing web page refers to how frequent the page is modified. For example, a landing web page 130 that is frequently updated may be more attractive to users 106 than a stale web page.

For example, the landing page quality score can be calculated using the following formula:

Landing page quality score=0.4*page link analysis score+0.1*freshness score+0.5*average performance of ads.

The landing page quality score can be normalized to be a value between 0 and 1. Other formulas can also be used to calculate the landing page quality score.

The landing page tuning tool 120 may provide suggestions for adjusting the landing web page 130 to improve the performance of the advertisement 104. For example, the landing page tuning tool may analyze the font size, layout, and color scheme of the landing web page 130 and provide suggestions on improvements of the web page 130.

Some ads 104 may perform well in certain geographical regions and not so well in others. For example, ads 104 associated with sales of products related to a particular sport may perform better in regions where sports teams associated with the particular sport are popular. The system 100 may include a database 132 that stores statistical information associated with performances of the advertisement 104 in various geographical regions over time. For example, the statistical information may include click through rates and conversion rates of the advertisement 104 when the advertisement 104 is shown to users 106 in various geographical regions.

The ad optimizer 114 may include a geolocation tuning tool 122 to collect the statistical information, process the collected statistical information, and output a visual representation of the processed information in the user interface 116 showing relative performances of the advertisement 104 in various geographical regions. For example, the GUI 116 may show a list of the top 10 geographical regions where the ad 104 performs best. The geolocation tuning tool 122 may wait until after the ad 104 has been run for a certain period of time in order to obtain sufficient statistical information before showing relative performances of the advertisement 104 in various geographical regions.

In some implementations, the geolocation tuning tool 122 may provide suggestions for increasing or decreasing ad budgets for particular geographical regions.

Some ads 104 may perform well on certain web sites or categories of web sites and not so well on others. For example, a certain ad 104 may perform better on a first news web site than on a second news web site. The advertiser 102 may not know which web sites are better matches for his ad 104, and may allocate equal budgets for targeting both first and second news web sites. A certain ad 104 may perform better on news web sites than on sports web sites. The advertiser 102 may not know for sure which categories of web sites are better matches for his ad 104, and may allocate equal budgets for targeting both news web sites and sports web sites. By providing information to the advertiser 102 on which web sites or categories of web sites provide better returns for ad spending, the advertiser 102 can adjust his ad budget to spend more on the web sites or categories of web sites that provide higher returns. The advertiser 102 can also know better what his potential audience is and tune the ads 104 better to suit the needs of the audience.

The database 132 may store statistical information associated with performances of the advertisement 104 in various web sites or categories of web sites over time. For example, the statistical information may include click through rates and conversion rates of the advertisement 104 when the advertisement 104 is shown on various web sites or categories of web sites.

The ad optimizer 114 may include a site tuning tool 124 to collect the statistical information, process the collected statistical information, and output a visual representation of the processed information in the user interface 116 showing relative performances of the advertisement 104 on various web sites or categories of web sites. For example, the GUI 116 may show a list of the top 10 web sites or categories of web sites where the ad 104 performs best. The site tuning tool may wait until after the ad 104 has been run for a certain period of time in order to obtain sufficient statistical information before showing relative performances of the advertisement 104 on various web sites or types of web sites.

In some implementations, the site tuning tool 124 may provide suggestions for increasing or decreasing ad budgets for particular web sites or categories of web sites.

The site tuning tool 124 may collect statistical information on performances of the advertisement 104 relative to its peer ads 104 in various web sites or categories of web sites over time. Peer ads 104 refer to ads 104 that target the same audience, such as ads 104 that target the same web sites or the same query keywords. Information about performance of an ad 104 relative to those of its peer ads 104 may provide insight on whether the advertiser 102 needs to adjust the ad 104. For example, if an ad 104 related to a sports product performs worse than its peer ads 104 on a sports web site, it may indicate that the advertiser 102 needs to adjust the ad 104 to better target the intended audience (e.g., the sports fans of particular sports teams).

The performance of an ad 104 may change during the course of the day. For example, an ad 104 may perform better during certain hours of a day, certain days of a week, certain months of a year, certain seasons of a year, or when certain events (e.g., sports events) occur, etc. The advertiser 102 may not know which time periods are better suited for his ad 104 and may allocate similar budgets for targeting various time periods. Some ads 104 may perform better during the morning while other ads 104 may perform better during the evening. Some ads 104 may perform better during weekdays, while other ads 104 may perform better during weekends. It may be useful to optimize ad spending so that the ad 104 is shown when it is more likely to be acted on by the user 106. By providing information to the advertiser 102 on which time periods provide better returns for ad spending, the advertiser 102 can adjust his ad budget to spend more during the time periods that provide higher returns. The advertiser 102 can also know better what his potential audience is (e.g., early risers or night owls) and tune the ads 104 better to suit the needs of the audience.

The database 132 may store statistical information associated with performances of the advertisement 104 in various time periods. For example, the statistical information may include click through rates and conversion rates of the advertisement 104 when the advertisement 104 is shown to users 106 at various time periods.

The ad optimizer 114 may include a time tuning tool 126 to collect the statistical information, process the collected statistical information, and output a visual representation of the processed information in the user interface 116 showing relative performances of the advertisement 104 at various time periods. For example, the GUI 116 may rank the performances of the ad 104 during different time periods. The time tuning tool 126 may wait until after the ad 104 has been run for a certain period of time in order to obtain sufficient statistical information before showing relative performances of the advertisement 104 during various time periods.

In some implementations, the time tuning tool 126 may provide suggestions for increasing or decreasing ad budgets for particular time periods.

The time tuning tool 126 may collect statistical information on performances of the advertisement 104 relative to peer ads 104 during various time periods. Information about performance of an ad 104 relative to those of its peers may provide insight on whether the advertiser 102 needs to adjust the ad 104. For example, if an ad 104 for a flower shop performs worse than its peers during Valentine, it may indicate that the advertiser 102 needs to improve the ad 104 to better target the intended audience (e.g., buyers of flowers).

The users 106 can be connected to the information system 100 through a network 132, which can be, e.g., the Internet.

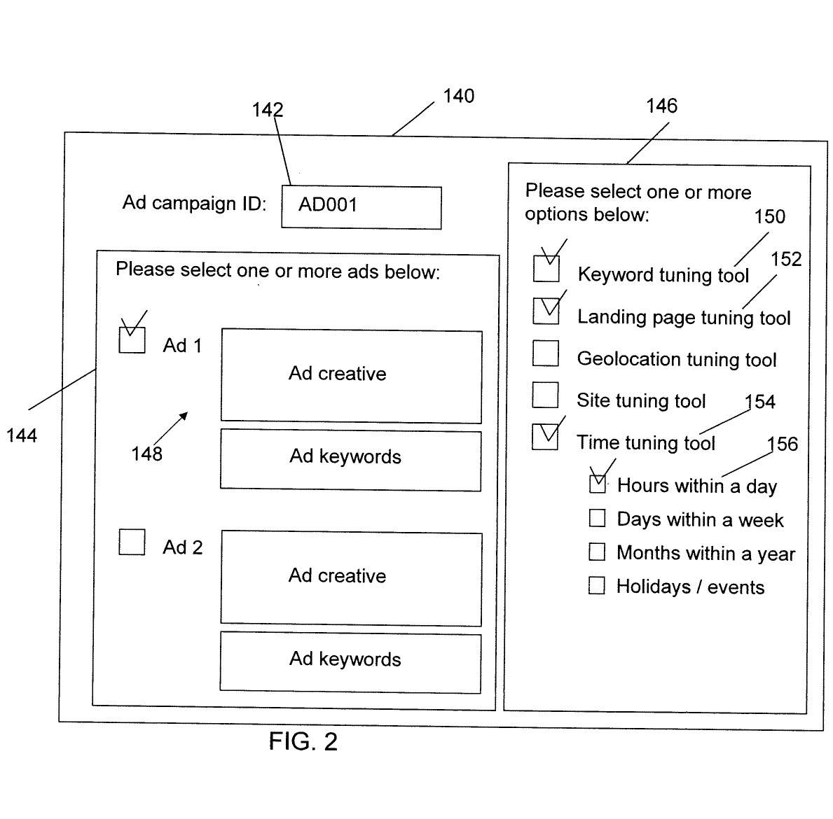

FIG. 2 shows an example graphical user interface (GUI) 140 having an input text box 142 to allow an advertiser 102 to identify an ad campaign, options 144 for selecting one or more ads associated with the ad campaign for receiving feedback, and options 146 for selecting which tools to use for generating feedback information. In the example shown in FIG. 2, the advertiser 102 selected the first ad 148 to receive feedback information, and selected an option 150 to use the keyword tuning tool 118, an option 152 to use the landing page tuning tool 120, and an option 154 to use the time tuning tool 126 to generate the feedback information. For the time tuning tool 126, the advertiser 102 selected an option 156 to show performance of the ad 104 for various hours within a day.

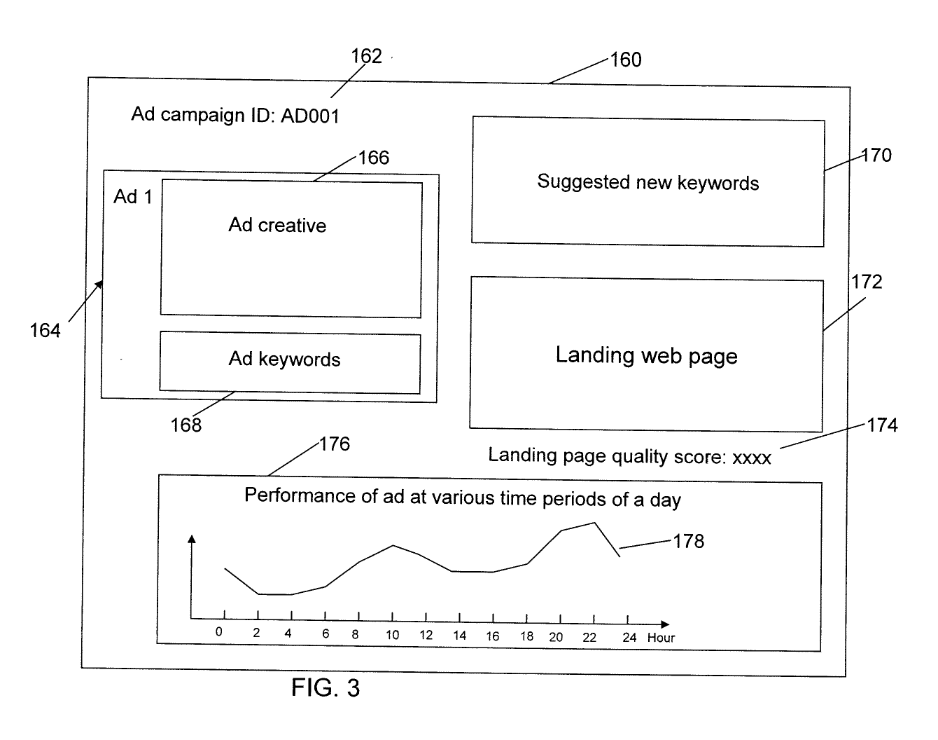

FIG. 3 shows an example graphical user interface (GUI) 160 showing the feedback information provided by the ad optimizer 114 based on the options the advertiser 102 selected in FIG. 2. In the example of FIG. 3, the GUI 150 shows feedback information generated by the keyword tuning tool 118, the landing page tuning tool 120, and the time tuning tool 126.

The GUI 160 shows the campaign identifier 162 and the selected ad 164, including an ad creative 166 and ad keywords 168. The GUI 160 shows the new keywords 170 suggested by the keyword tuning tool 118. The GUI 160 shows a landing web page 172 and a landing web page quality score 174 provided by the landing page tuning tool 120. The GUI 160 includes a graph 176 (generated by the time tuning tool 126) showing a curve 178 representing the relative performances of the ad during various hours of the day.

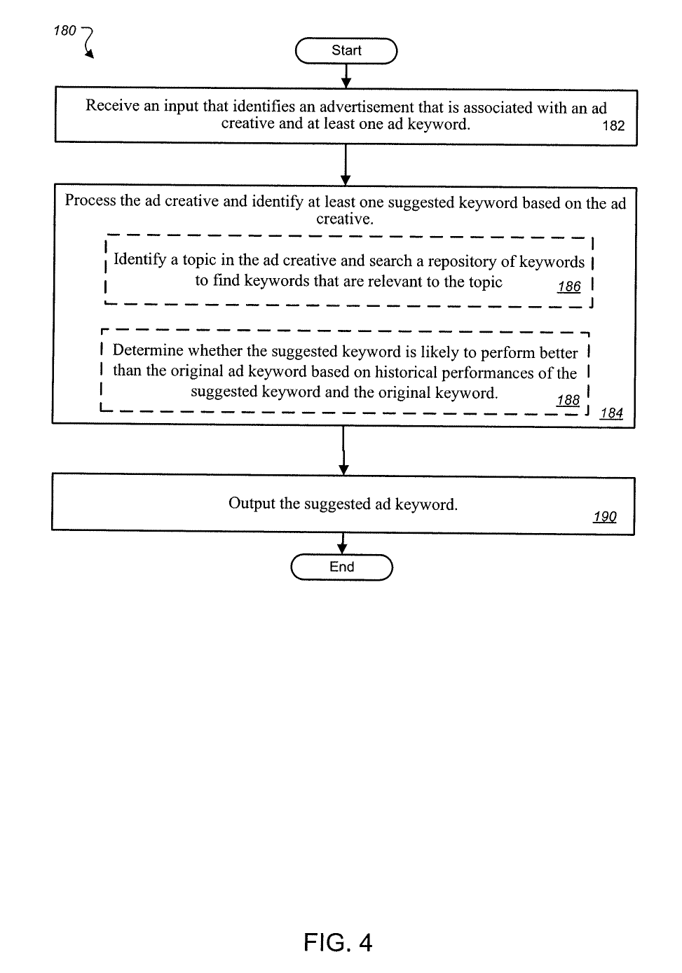

FIG. 4 is a flow diagram of an example process 180 for providing feedback to an advertiser 102. For example, the process 180 can be performed by the information system 100 of FIG. 1. An input is received in which the input identifies an advertisement that is associated with an ad creative and at least one associated term (e.g., ad keyword) (182). The ad creative is processed and at least one suggested term (e.g., keyword) is generated based on the ad creative (184). For example, a topic in the ad creative is identified and a repository of keywords is searched to find keywords that are relevant to the topic (186). In some examples, the keyword tuning tool 118 determines whether the suggested new keyword is likely to perform better than the original provided ad keyword based on historical performances of the suggested new keyword and the original provided ad keyword (188). The suggested new keyword is provided to the advertiser 102 if the suggested new keyword is likely to perform better than the original provided ad keyword (190). For example, the keyword tuning tool 118 can be configured to identify suggested keywords that have narrower meanings than the original provided ad keywords. The original provided ad keyword can be associated with a genus that includes a plurality of species, and the suggested keyword can be associated with one of the species. For example, if the ad creative includes a product name or a brand name, the original provided ad keyword includes a broad generic term associated with the product name or brand name, the keyword tuning tool 118 may suggested a new ad keyword that is the product name or the brand name.

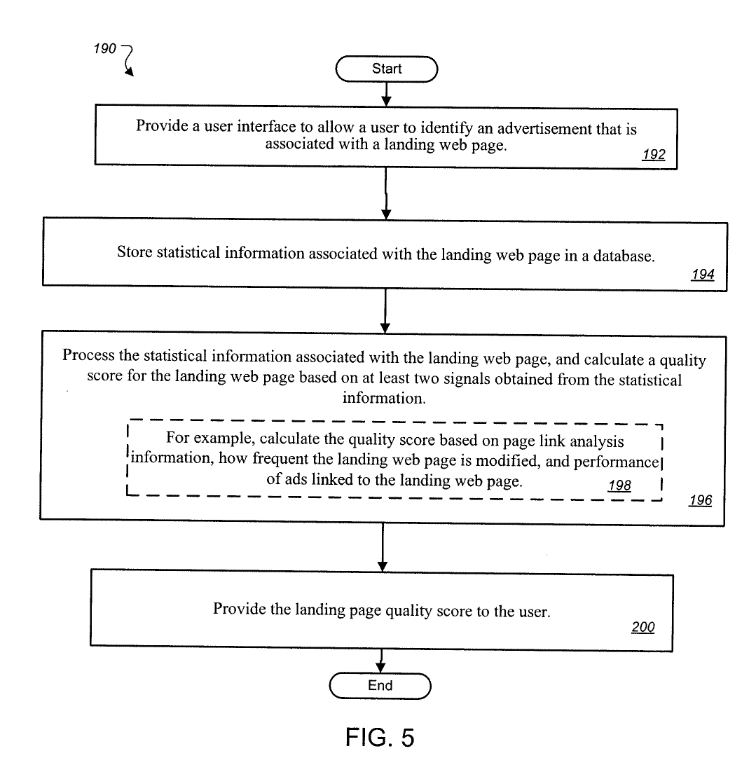

FIG. 5 is a flow diagram of an example process 190 for providing feedback on the quality of a landing web page of an ad. For example, the process 190 can be implemented by the system 100. A user interface is provided to allow a user to identify an advertisement that is associated with a landing web page (192). For example, the ad and landing web page can be the ad 104 and landing web page 130 of FIG. 1. A database stores statistical information associated with the landing web page (194). For example, the database can be the keyword repository 128. The statistical information associated with the landing web page is processed, and a quality score for the landing web page is generated based on at least two signals obtained from the statistical information (196). For example, a landing web page having a higher quality score contributes more positively to the performance of the advertisement than a landing web page having a lower quality score. The quality score can be derived based on page link analysis information, how frequent the landing web page is modified, and/or performance of ads linked to the landing web page (198). The quality score is provided to the user through the user interface (200).

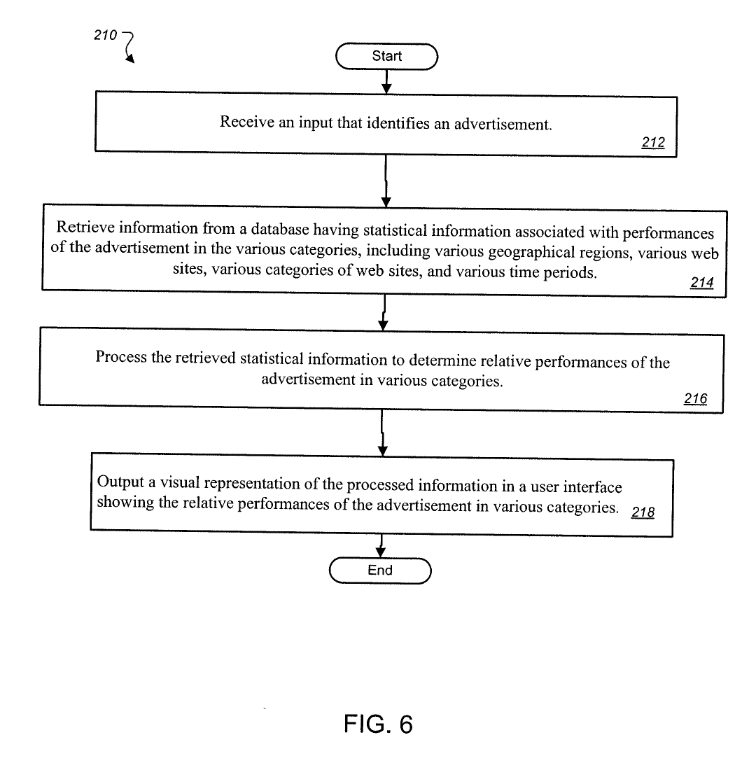

FIG. 6 is a flow diagram of an example process 210 for providing feedback on performances of an advertisement in various categories, such as performances of the advertisement in various geographical regions, performances of the advertisement at various web sites, performances of the advertisement at various categories of web sites, and performances of the advertisement during various time periods. For example, the process 210 can be implemented by the system 100. An input is received that identifies an advertisement (212). Information is retrieved from a database having statistical information associated with performances of the advertisement in the various categories (214). The retrieved statistical information is processed to determine relative performances of the advertisement in various categories (216). A visual representation of the processed information is output in a user interface showing relative performances of the advertisement in various categories (218).

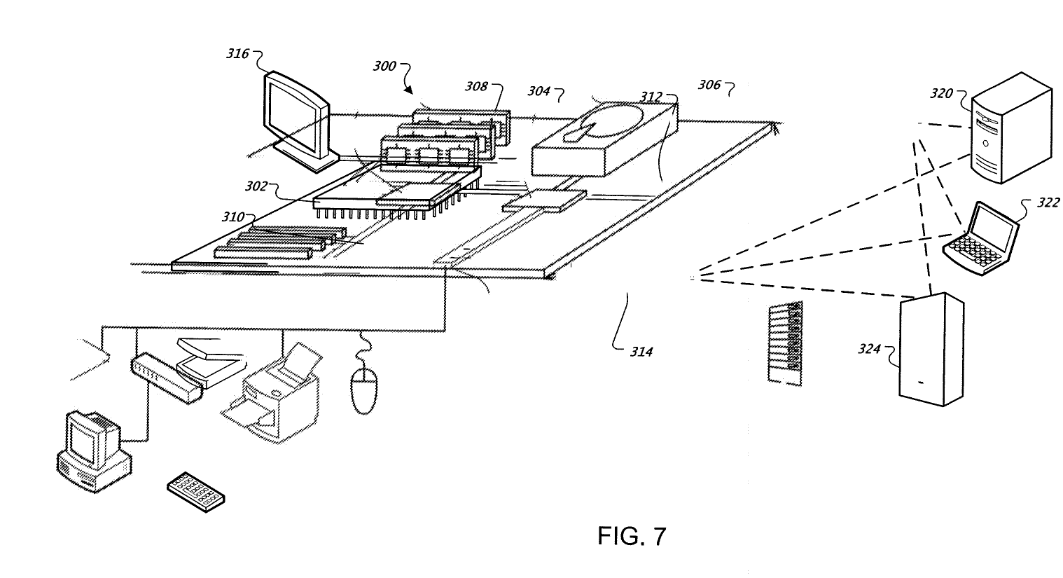

FIG. 7 is a schematic representation of a general computing system 300 that can be used to implement the information system 100. Computing device 300 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

Computing device 300 includes a processor 302, memory 304, a storage device 306, a high-speed interface 308 connecting to memory 304 and high-speed expansion ports 310, and a low speed interface 312 connecting to low speed bus 314 and storage device 306. Each of the components 302, 304, 306, 308, 310, and 312, are interconnected using various busses, and may be mounted on a common motherboard or in other manners as appropriate. The processor 302 can process instructions for execution within the computing device 300, including instructions stored in the memory 304 or on the storage device 306 to display graphical information for a GUI on an external input/output device, such as display 316 coupled to high speed interface 308. In other implementations, multiple processors and/or multiple buses may be used, as appropriate, along with multiple memories and types of memory. Also, multiple computing devices 300 may be connected, with each device providing portions of the necessary operations (e.g., as a server bank, a group of blade servers, or a multi-processor system).

The memory 304 stores information within the computing device 300. In one implementation, the memory 304 is a volatile memory unit or units. In another implementation, the memory 304 is a non-volatile memory unit or units. The memory 304 may also be another form of computer-readable medium, such as a magnetic or optical disk.

The storage device 306 is capable of providing mass storage for the computing device 300. In one implementation, the storage device 306 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 304, the storage device 306, memory on processor 302, or a propagated signal.

The high speed controller 308 manages bandwidth-intensive operations for the computing device 300, while the low speed controller 312 manages lower bandwidth-intensive operations. Such allocation of functions is exemplary only. In one implementation, the high-speed controller 308 is coupled to memory 304, display 316 (e.g., through a graphics processor or accelerator), and to high-speed expansion ports 310, which may accept various expansion cards (not shown). In the implementation, low-speed controller 312 is coupled to storage device 306 and low-speed expansion port 314. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 300 may be implemented in a number of different forms, as shown in the figure. For example, it may be implemented as a standard server 320, or multiple times in a group of such servers. It may also be implemented as part of a rack server system 324. In addition, it may be implemented in a personal computer such as a laptop computer 322. Each of such devices (e.g., standard server, rack server system, personal computer, and laptop computer) may contain one or more of computing device 300, and an entire system may be made up of multiple computing devices 300 communicating with each other.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse, trackball, touch-sensitive screen, or iDrive-like component) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications and methods have been described, it should be recognized that numerous other applications are contemplated.

For example, the user 106 and the advertiser 102 may access the information system 100 through any kind of devices, such as desktop computers, laptop computers, mobile devices, etc. Though reference is made to determination of effectiveness of advertisements, the information system 100 can determine the effectiveness of other forms of content including other forms of sponsored content. The ads 104 can include, e.g., text advertisements, audio advertisements, video advertisements, or Flash advertisements. The on-line content can include audio programs, animation, and on-line games. The keywords can be associated with a single advertisement, multiple advertisements, and/or a topic associated with a good and/or service.

In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

1. A system comprising:
one or more processing devices; and
one or more machine-readable hardware storage devices storing instructions that are executable by the one or more processing devices to perform operations comprising:
processing an ad creative for content;
parsing a query log to identify a set of search queries that include descriptors that are relevant to the content in the ad creative;
selecting, from the set of search queries, at least one descriptor that is used in the identified set of search queries a higher number of times, relative to numbers of times with which other descriptors are used in the identified set of search queries; and
outputting the at least one selected descriptor as a suggested descriptor for association with the ad creative.

2. The system of claim 1, wherein the operations further comprise:
storing a plurality of descriptors in a repository, wherein the plurality of descriptors comprises the at least one selected descriptor; and
identifying, at least partly based on a search of the repository, the at least one selected descriptor.

3. The system of claim 1, wherein selecting comprises:
selecting the at least one descriptor based on a matching between content in the at least one descriptor and the content in the ad creative.

4. The system of claim 2, wherein the operations further comprise:
storing historical performances of the descriptors; and
determining whether the at least one selected descriptor is likely to provide an increased level of performance relative to a level of performance provided by an original provided descriptor based on historical performances of the at least one selected descriptor and the original provided descriptor;
wherein outputting comprises outputting the at least one selected descriptor if the at least one selected descriptor is likely to provide the increased level of performance relative to the level of performance provided by the original provided descriptor.

5. The system of claim 1, wherein the at least one selected descriptor comprises at least one keyword or key phrase.

6. The system of claim 1, wherein the operations further comprise:
identifying a topic in the ad creative; and
searching a repository of descriptors to find descriptors that are relevant to the topic;
wherein selecting the at least one descriptor comprises:
selecting the at least one descriptor at least partly based on searching and based on the content in the ad creative.

7. The system of claim 1, wherein the at least one selected descriptor has a narrower meaning than an original provided descriptor.

8. The system of claim 1, wherein an original provided descriptor is associated with a genus that comprises a plurality of species, and the at least one selected descriptor is associated with one of the species.

9. The system of claim 1, wherein the ad creative comprises a product name or a brand name, an original provided descriptor comprises a generic term associated with the product name or the brand name, and the at least one selected descriptor comprises the product name or the brand name.

10-18. (canceled)

19. A method performed by one or more computing devices, comprising:
processing, by the one or more computing devices, an ad creative for content;
parsing, by the one or more computing devices, a query log to identify a set of search queries that include descriptors that are relevant to the content in the ad creative;
selecting, from the set of search queries, at least one descriptor that is used in the identified set of search queries a higher number of times, relative to numbers of times with which other descriptors are used in the identified set of search queries; and
outputting the at least one selected descriptor as a suggested descriptor for association with the ad creative.

20-22. (canceled)

23. The method of claim 19, further comprising:
storing a plurality of descriptors in a repository, wherein the plurality of descriptors comprises the at least one selected descriptor; and
identifying, at least partly based on a search of the repository, the at least one selected descriptor.

24. The method of claim 19, wherein selecting comprises:
selecting the at least one descriptor based on a matching between content in the at least one descriptor and the content in the ad creative.

25. The method of claim 23, further comprising:
storing historical performances of the descriptors; and
determining whether the at least one selected descriptor is likely to provide an increased level of performance relative to a level of performance provided by an original provided descriptor based on historical performances of the at least one selected descriptor and the original provided descriptor;
wherein outputting comprises outputting the at least one selected descriptor if the at least one selected descriptor is likely to provide the increased level of performance relative to the level of performance provided by the original provided descriptor.

26. The method of claim 19, wherein the at least one selected descriptor comprises at least one keyword or key phrase.

27. The method of claim 19, further comprising:
identifying a topic in the ad creative; and
searching a repository of descriptors to find descriptors that are relevant to the topic;
wherein selecting the at least one descriptor comprises:
selecting the at least one descriptor at least partly based on searching and based on the content in the ad creative.

28. The method of claim 19, wherein the at least one selected descriptor has a narrower meaning than an original provided descriptor.

29. The method of claim 19, wherein an original provided descriptor is associated with a genus that comprises a plurality of species, and the at least one selected descriptor is associated with one of the species.

30. One or more machine-readable hardware storage devices storing instructions that are executable by one or more processing devices to perform operations comprising:
processing an ad creative for content;
parsing a query log to identify a set of search queries that include descriptors that are relevant to the content in the ad creative;
selecting, from the set of search queries, at least one descriptor that is used in the identified set of search queries a higher number of times, relative to numbers of times with which other descriptors are used in the identified set of search queries; and
outputting the at least one selected descriptor as a suggested descriptor for association with the ad creative.

31. The one or more machine-readable hardware storage devices of claim 30, wherein the operations further comprise:
storing a plurality of descriptors in a repository, wherein the plurality of descriptors comprises the at least one selected descriptor; and
identifying, at least partly based on a search of the repository, the at least one selected descriptor.

32. The one or more machine-readable hardware storage devices of claim 30, wherein selecting comprises:
selecting the at least one descriptor based on a matching between content in the at least one descriptor and the content in the ad creative.

33. The one or more machine-readable hardware storage devices of claim 31, wherein the operations further comprise:
storing historical performances of the descriptors; and
determining whether the at least one selected descriptor is likely to provide an increased level of performance relative to a level of performance provided by an original provided descriptor based on historical performances of the at least one selected descriptor and the original provided descriptor;
wherein outputting comprises outputting the at least one selected descriptor if the at least one selected descriptor is likely to provide the increased level of performance relative to the level of performance provided by the original provided descriptor.

34. The one or more machine-readable hardware storage devices of claim 30, wherein the at least one selected descriptor comprises at least one keyword or key phrase.
